(19) United States
(12) Patent Application Publication
(10) Pub. No.: US 2011/0018287 A1
(43) Pub. Date: Jan. 27, 2011

(54) Portable Hinge Lock

(76) Inventor: Pamela Wise, Pacific Palisades, CA (US)

Correspondence Address: Cislo & Thomas LLP, 1333 2nd Street, Suite #500, Santa Monica, CA, 90401-4110, US

(21) Appl. No.: 12/507,933

(22) Filed: Jul. 23, 2009

(51) Int. Cl. E05C 19/18

(52) U.S. Cl. 292/288

(57) ABSTRACT

A portable device for locking a door in the closed position that fits over a hinge on the door. The device is of a shape and size capable of locking many different door sizes having hinges of various sizes and has two arms extending from a circular inner portion that encircles the hinge when the device is applied. The device may contain a ratchet in the circular inner portion to facilitate locking many different door sizes. Application is quick and easy by sliding the device over the hinge, and if the device includes a ratchet, ratcheting the arms in place, and removal is equally as effortless by sliding the device off of the hinge. Removal may also include resetting the arms by depressing a release pin that disengages the ratchet.

### TECHNICAL FIELD

This application relates to a device for securing a hinge in the closed position, the hinge being located on a door such as a door to a house, apartment, hotel room, a door to a room in a structure such as a bedroom door, or a cabinet door. The device can be used as a safety mechanism to prevent seniors, children, and others from opening the door.

### BACKGROUND ART

Safety mechanisms for seniors, children, and others come in many shapes and forms; however, many are difficult to use. For example, the safety mechanisms may be very heavy, cumbersome to apply and remove for an ordinary user, ineffective, flimsy, or can ruin the surface of the door or wall upon application.

Many such devices have multiple components making their application challenging to even the most mechanically adept individuals. Oftentimes, the components must be artfully applied so that they “match” together to ensure a proper, secure lock. Any slight misapplication can render the device ineffective.

Safety devices with multiple components or confusing instructions can require a significant amount of time to apply. Difficult, timely application is a disincentive for caregivers of the elderly, children, and others who are often pressed for time.

Also, many safety mechanisms must be permanently affixed to a structure, thereby requiring additional tools to apply the device. Affixing the device may prevent the mechanism from being reused, usable in a number of locations, for example, throughout one's home, office, or care center, or usable while traveling or visiting friends and relatives.

There is a need in the art for a device that can lock a door in place that is easy to use, light weight, quickly applied, effective, sturdy, and portable that does not mar or otherwise damage the surface to which it is applied.

### DISCLOSURE OF INVENTION

The present application is directed to a device for locking a door in place that is positioned over the hinge of the door. The device is sturdy, and configured such that it can be set in place and removed without additional tools making it portable and usable in a number of locations and settings. Also, the device is configured to be applied to a number of hinge sizes so that it can be used on doors of all sizes and in various locations.

### BRIEF DESCRIPTION OF DRAWINGS

FIG. 1 is a perspective view of an embodiment of the portable hinge lock.

FIG. 2 is a front view of an embodiment of the portable hinge lock.

FIG. 3 is a top down view of an embodiment of the portable hinge lock.

FIG. 4 is a front view of an embodiment of the portable hinge lock with an adjustable arm.

FIG. 5 is a top down view of an embodiment of the portable hinge lock with an adjustable arm.

FIG. 6 is a front view of an embodiment of the portable hinge lock with a pin lock.

FIG. 7 is a front view of an embodiment of the portable hinge lock with a lip on one of the arms.

FIG. 8 is a view of an embodiment of the portable hinge lock with ratchet.

FIG. 9 is a top view of an embodiment of the portable hinge lock with ratchet in the open (door closed) position.

FIG. 10 is a top view of an embodiment of the portable hinge lock with ratchet in the closed (door open) position.

FIG. 11 is a view of an embodiment of the portable hinge lock in use on a door.

FIG. 12 is a view of an embodiment of the portable hinge lock in use on a cabinet.

FIG. 13 is a view of an embodiment of the portable hinge lock having an adjustable arm in use on a door.

### BEST MODE FOR CARRYING OUT THE INVENTION

The detailed description set forth below in connection with the appended drawings is intended as a description of presently-preferred embodiments and is not intended to represent the only forms in which the present device may be constructed or utilized. The description sets forth the functions and the sequence of steps for constructing and operating the device in connection with the illustrated embodiments. However, it is to be understood that the same or equivalent functions and sequences may be accomplished by different embodiments that are also intended to be encompassed within the spirit and scope of this application.

FIG. 1 depicts a perspective view of one embodiment of the portable hinge lock of the present invention 10 for locking a door having a hinge in the closed position comprising a first arm 20 and a second arm 30, each having a left side and a right side, the left side of the first arm 40 and the right side of the first arm 50, and the left side of the second arm 70, and the right side of the second arm 60, the right side of the first arm 50 may have an ovoid, trapezoidal, rectangular or amorphous shape and the left side of the first arm 40 having a straight vertical shape, and the right side of the second arm 60 having a straight vertical shape and the left side of the second arm may have an ovoid, rectangular, square or amorphous shape 70, the first arm 20 having a length greater than its height and the second arm 30 having a length greater than its height, a circular inner unit 80 having a left side 90 and a right side 100, a front side 110 and a back side 120, and a hollow inside 130, the left side of the circular inner unit 90 attached to the right side of the second arm 60 and the right side of the circular inner unit 100 attached to the left side of the first arm 40, the front side 110 of the circular inner unit 80 rising up from the first arm 20 and second arm 30 and having a circular shape capable of encircling the hinge, and the back side 120 of the circular inner unit 80 having an opening for receiving the hinge in the hollow inside 130; wherein the embodiment removeably fits over the hinge such that the circular inner unit 80 receives the hinge and the first arm 20 rests on the door and the second arm 30 rests on the door or a wall adjacent to the door or vice versa, depending on the orientation of the door and the adjacent wall. It is understood that the device can be used with either the first arm 20 to the right and the second arm 30 to the left, or the first arm 20 to the left and the second arm 30 to the right and the top and bottom of the device are interchangeable depending on the need for orienting the device over a hinge. For example, when the hinge is locked on the right or left side of the door. Optionally, the inventive device may have a slit opening 320 in each of the arms to enhance slidability and stability of the device. The split opening supplemental wedge 320 has a length greater than its width and may extend from the circular inner unit to the outside end of each arm.

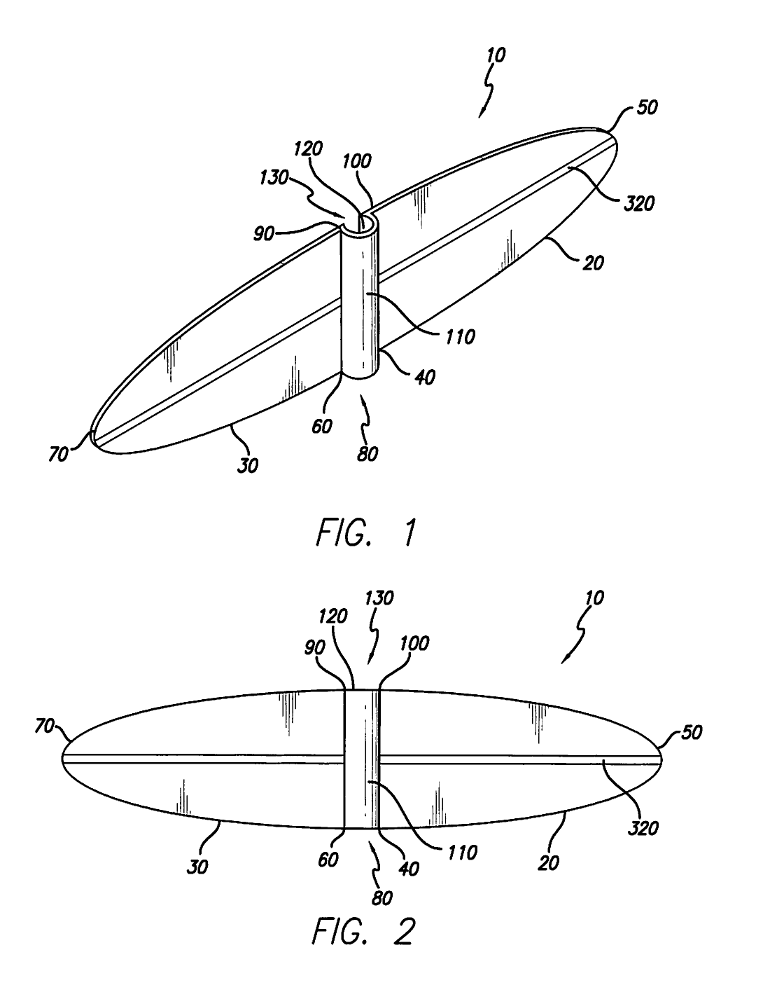

FIG. 2 shows a front view of one embodiment 10 comprising a first arm 20 and a second arm 30, each having a left side and a right side, the left side of the first arm 40 and the right side of the first arm 50, and the left side of the second arm 70, and the right side of the second arm 60, the right side of the first arm 50 may have an ovoid, trapezoidal, rectangular, square or amorphous shape and the left side of the first arm 40 having a straight vertical shape, and the right side of the second arm 60 having a straight vertical shape and the left side of the second arm 70 may have an ovoid, trapezoidal, rectangular, square, or amorphous shape, the first arm 20 having a length greater than its height the second arm 30 having a length greater than its height, a circular inner unit 80 having a left side 90 and a right side 100, a front side 110 and a back side 120, and a hollow inside 130, the left side 90 of the circular inner unit 80 attached to the right side of the second arm 60 and the right side 100 of the circular inner unit 80 attached to the left side of the first arm 40, the front side 110 of the circular inner unit 80 rising up from the first arm 20 and second arm 30 and having a circular shape capable of encircling the hinge, and the back side 120 of the circular inner unit 80 having an opening for receiving the hinge in the hollow inside 130; wherein the embodiment fits over the hinge such that the circular inner unit 80 receives the hinge and the first arm 20 rests on the door and the second arm 30 rests on the door or a wall adjacent to the door or vice versa, depending on the orientation of the door and the adjacent wall. It is understood that the device can be used with either the first arm 20 to the right and the second arm 30 to the left, or the first arm 20 to the left and the second arm 30 to the right and the top and bottom of the device are interchangeable depending on the need for orienting the device over a hinge. For example, when the hinge is locked on the right or left side of the door. Optionally, the device may have a supplemental wedge 320 in each of the arms to enhance slidability and stability of the device. The supplemental wedge 320 has a length greater than its width and may extend from the circular inner unit to the ovoid end of each arm.

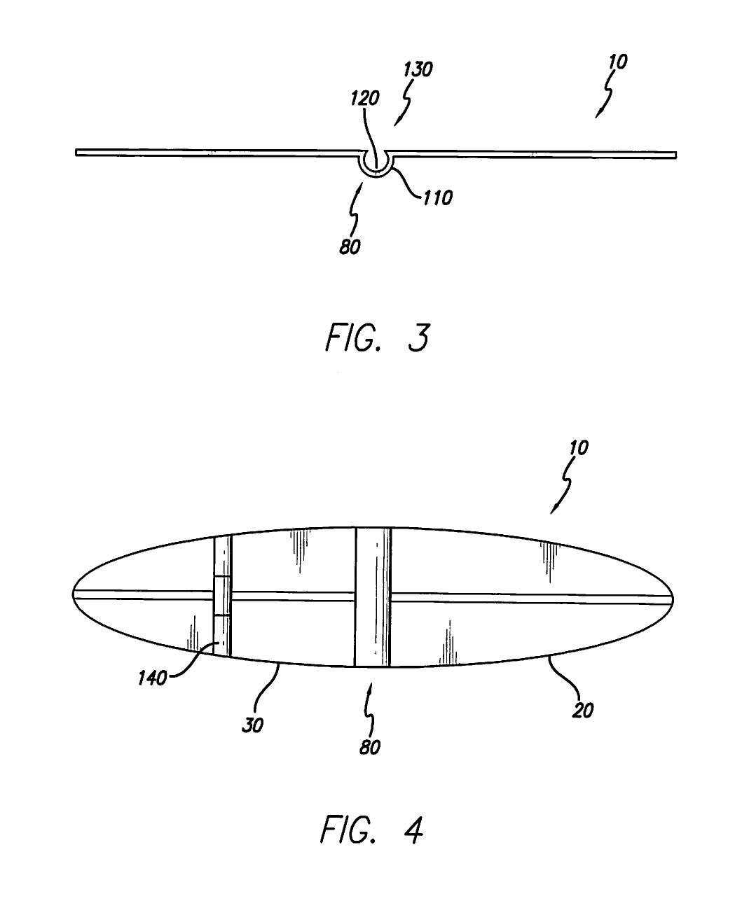

FIG. 3 depicts a top down view of one embodiment where the circular inner unit 80 is open on the back side 120 of the device and has a size and shape capable of receiving the hinge. FIG. 2 further shows the opening in the back side 120 of the circular inner unit 80 as being narrower than the largest diameter of the circular inner unit 80 such that the circular inner unit 80 fits securely over the hinge on the door.

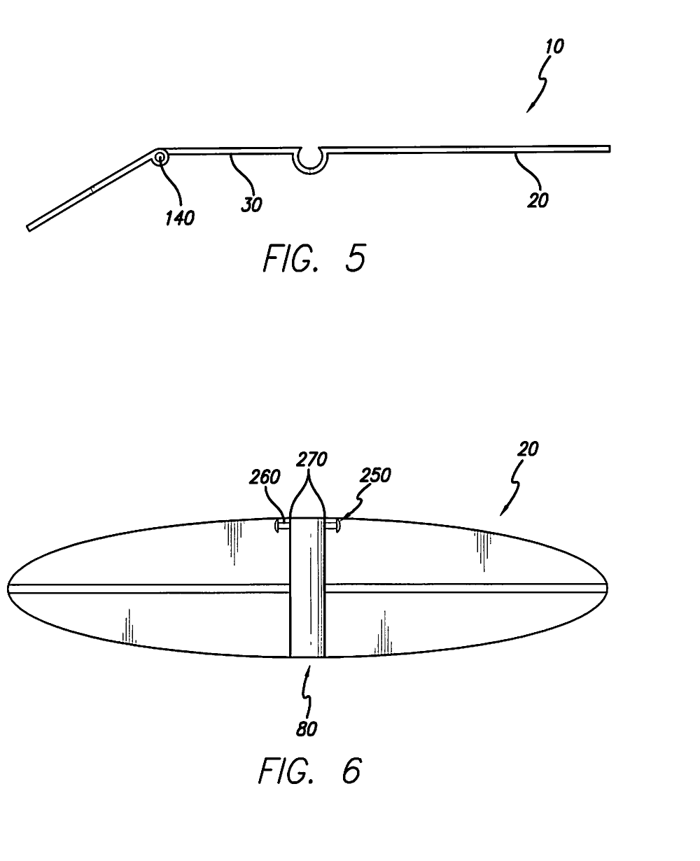

FIGS. 4 and 5 show yet another example of an embodiment 10 wherein the second arm 30 is adjustable by way of a foldable component 140. Alternatively, the first arm 20 may be adjustable by having a foldable component 140. As noted above, the device can be used interchangeably depending on the need for orienting the device over a hinge. For example, when a hinge is on the right or left side of the door and when an adjacent wall is perpendicular and close to the left or right side of the door. The foldable component 140 is vertical such that it can fold up to allow the device 10 to be positioned over the hinge on a door adjacent to a substantially perpendicular wall. The foldable component 140 permits the device to be used in close, tight spaces, or on hinges located in narrow areas. FIG. 13 depicts one embodiment 10 with an adjustable arm 150 with a foldable component 140 in use in a tight corner space having a perpendicular wall 160 next to the wall adjacent 180 to the door 170. The adjustable arm 150 may be the first or second arm and may be used in any orientation, for example, if the hinge 190 is positioned on the right side of a door that is adjacent to a substantially perpendicular wall, the device having an adjustable arm 150 can be applied over the hinge 190 such that the foldable component 140 allows the device to be used in a tight corner space having a wall perpendicular to the wall adjacent to the door on the right side of a door. The device may have a ratchet along with the foldable component in one or both arms. As shown in FIG. 13, the wall perpendicular to the wall adjacent to the door is on the left side of a door. The device may be used in either configuration. When a hinge 190 is in close proximity to a perpendicular wall 160, the device can be applied to such a configuration utilizing the foldable component 140. When the device 10 is slid over the hinge 190, one of the arms 150 having the foldable component 140 can be adjusted to that a portion of the arm 210 rests on the adjacent wall 180 and folds to accommodate the perpendicular wall 160 and a portion of the arm 200 rests on the perpendicular wall 160. The stability and strength of the device is not compromised by the foldable unit 140. The foldable unit 140 enhances the usability of the device 10, extending the number of possible locations of use.

Yet another embodiment 10 is shown in FIG. 6 wherein the device comprises a pin lock 250 on the top of the device 10 to lock it over a hinge. The pin lock 250 may have a configuration such that a pin 260 fits through two holes 270 in the top of the circular inner unit 80 of the inventive device 10. Insertion of the pin 260 into the two holes 270 securely locks the device 10 on the hinge.

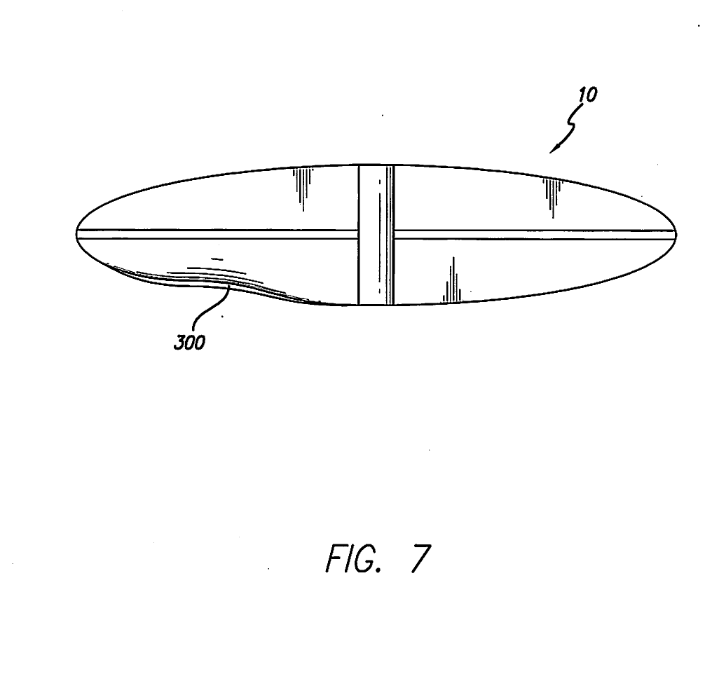

As shown in FIG. 7, one embodiment 10 may have a lip 300 on one or more of the arms. The lip 300 is positioned in the bottom of the one or more arms so that it can be used as leverage for an individual that wishes to remove the device. The lip 300 is of a size and shape such that a thumb or other finger can fit under it and assist in sliding the device off of the hinge.

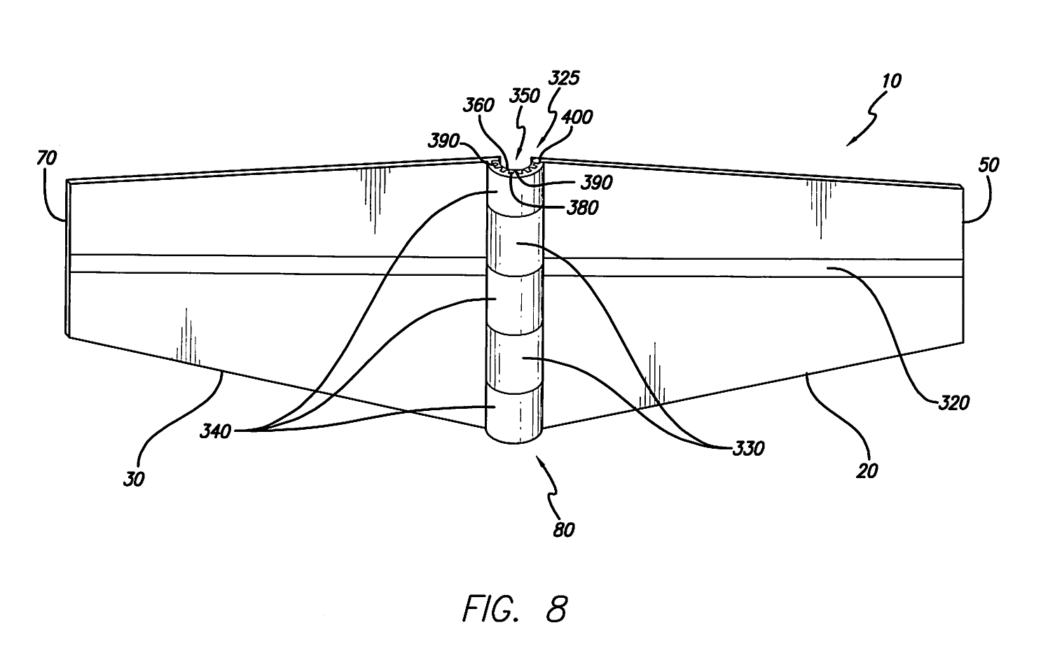

FIG. 8 is a view of an embodiment of the portable hinge lock 10 with ratchet 325. The circular inner unit 80 with ratchet 325 formed by the interlocking edges of the left side of the first arm 330 and the interlocking edges of the right side of the second arm 340, the circular inner unit 80 having a front side and a back side, and a hollow inside, the front side of the circular inner unit rising up from the first arm and second arm and having a circular shape capable of encircling a semi-circular gear wheel having an inside and an outside, the circular inner unit allows movement and adjustment of the arms to position the device over a hinge to lock a door. With the ratchet 325, the arms 20 and 30 may be positioned at different degrees to accommodate door moldings and different door configurations. In the embodiment with ratchet 325, a gear wheel 350 having an inside 360 and an outside 370, the gear wheel 350 having one or more teeth 380 on the outside 370, and the back side of the circular inner unit having one or more fingers 390 for engaging the one or more teeth 380 on the gear wheel 350, and the inside of the gear wheel shaped to receive the hinge. The gear wheel 350 has one or more teeth 380, is preferably a predominantly semi-circular shape, and is positioned inside the circular inner unit 80. The teeth 380 of the gear wheel 350 are of a size and shape to engage the one or more pawls or one or more fingers 390 on the back side of the circular inner unit 80 surrounding the gear wheel 350. The left side of the first arm and the right side of the second arm contain interlocking extensions 330 and 340, respectively, having a front side and a back side that are laced together to form a circular inner unit 80 surrounding the gear wheel 350, the interlocking extensions having one or more pawl or finger 390 on the inside capable of fitting into and engaging the teeth 380 of the gear wheel 350 to help position the arms 20 and 30 in an open position and prevent the arms from moving to a closed position. The device also has a ratchet release pin 400 that releases the arms 20 and 30, the one or more fingers 390, the one or more pawls 390, and/or the inner gear wheel 350 so that the device can be adjusted into an alternative position. The right side of the first arm 50 may have an ovoid, trapezoidal, rectangular, or amorphous shape and the left side of the first arm may have an interlocking edge, and the right side of the second arm 70 may have an interlocking edge 350 and the left side of the second arm may have an ovoid, trapezoidal, rectangular, square, or amorphous shape, and the right side of the second arm may have an interlocking edge 340, the first arm 20 may have a length greater than its height and the second arm 30 may have a length greater than its height. The device with ratchet can be ratcheted into position to rest on the door or a wall adjacent to the door and is useful in many different configurations. The device may also have an additional ridge 320 to give extra strength to the arms, 20 and 30. In addition, one or more of the arms may have a bent shape, for example, so that the device forms the shape of a “z” in order to accommodate the multiple configurations of doors with hinges.

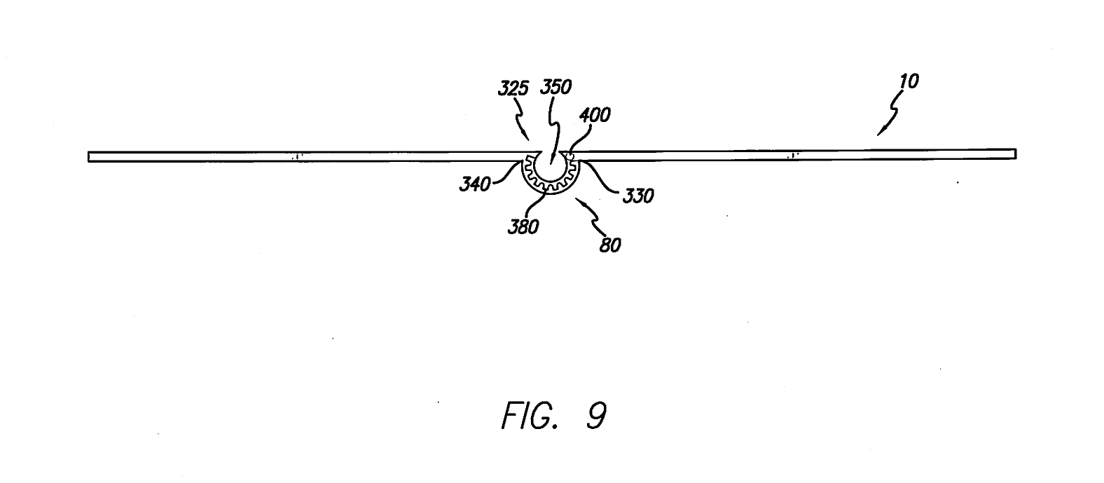

FIG. 9 is a top view of an embodiment of the portable hinge lock with ratchet 325 in the open (door closed) position. The top of the semi-circular gear wheel 350 with one or more teeth 380 is shown surrounded by the circular inner unit 80 made up of the ends of the arms containing interlocking extensions. The interlocking extensions are laced together to form the circular inner unit 80 surrounding the gear wheel 350. The right side of the left arm 340 has an interlocking shape to engage the left side of the right arm 330, which also has an interlocking shape, together the interlocking extensions of the arms form circular inner unit 80 of the device. The inside of the circular inner unit has one or more pawls or fingers 390 that fit into the teeth 380 of the gear wheel 350 and help position the device over the hinge and adjacent to the door and any other structure next to the door, the applicable hinges being on doors having any configuration. The release pin 400 assists in releasing the ratchet 325 to help position and reposition the device over a hinge.

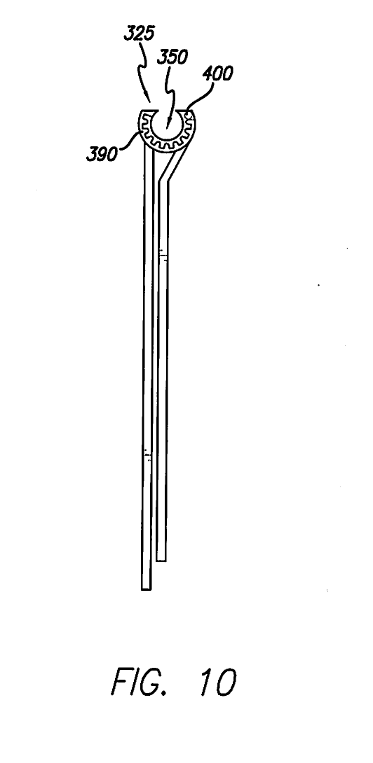

FIG. 10 is a top view of an embodiment of the portable hinge lock with ratchet 325 in the closed (door open) position. The semi-circular gear wheel 350 is shown surrounded by the arms 20 and 30 of the device. Also shown is the release pin 400. The device may have a bent first arm or a bent second arm, for example the arm may form a “z” shape in order to accommodate the hinge and the door. The bent shape of one of the arms is shown in FIG. 10.

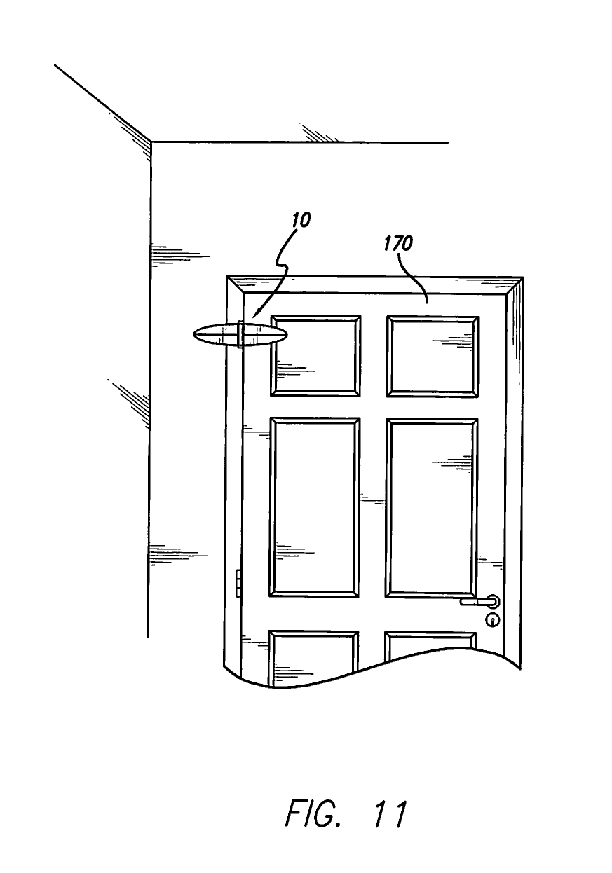

FIG. 11 depicts an embodiment 10 on use on a door 170 large enough for a human to walk through such as a door in a house, apartment, condo, garage or the like, or a door in a hotel, or other facility. All embodiments may be applied interchangeably meaning that there is no correct top of bottom of the device 10 and the device 10 may be applied so that the first arm rests on the door and the second arm rests on the adjacent wall and or a perpendicular wall. Alternatively, the device may be applied so that the second arm rests on the door and the first arm rests on the adjacent wall and or a perpendicular wall. The device shall be applied according to the orientation of the door and its hinge.

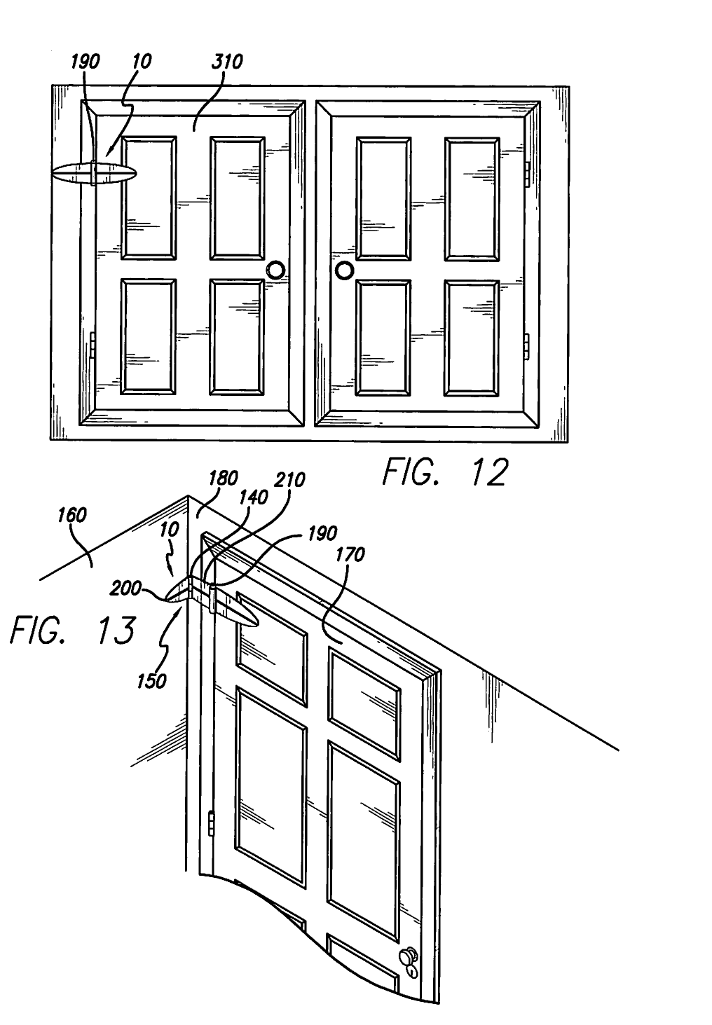

FIG. 12 depicts an embodiment of the present invention 10 in use on a hinge 190 on a cabinet door 310.

All of the embodiments are constructed of a sturdy material such as metal including steel, titanium, alloy, or other similar material; hard plastic; or other firm, sturdy material. The device may be made from recycled materials. To enhance slidability, the material of one or more embodiments may be perforated; for example, the material may have one or more holes of equal size or varying size, wherein the perforations do not compromise the stability and strength of the material.

In yet another embodiment, the device may have a first arm and a second arm each having a different length. This can allow application of the device in a number of locations where a hinge is on a door in a corner, a narrow location, or any location where one of the arms must have a length shorter than the other arm to fit over the hinge and lock the door closed. Alternatively, the device may have a first arm and a second arm each having equal length. The length of the first arm and the second arm must be of a size such that the device locks the hinge in the closed position and locks the door closed. Such size may be varied and may be about 0.3 inches to 9.0 inches. The first arm may have a length of about 1.0 inches to 5.0 inches and the second arm may have a length of about 1.0 inches to 5.0 inches.

The terminal ends of the arms may be circular, trapezoidal, square, rectangular, or any amorphous shape. In the figures, the terminal ends are shown as either circular or trapezoidal, but the device is not to be limited to the shape of the terminal ends shown.

The width of the device must be of a size such that the device is stable and sturdy and locks the hinge in the closed position and locks the door closed. For example, the first arm, second arm, and circular inner unit may have a width of about 0.01 inches to 1.0 inches. The largest diameter of the circular inner unit may be about 0.3 inches to 1.0 inches, and the opening in the back side of the circular inner unit may be about 0.1 inches to 0.99 inches. The height of the circular inner unit may be about 0.01 inches to 5.0 inches.

The foldable component may be a hinge, two or more cylindrically joined pieces that pivot, a housing with interior pin that pivots, and/or a pliable section of an arm made of a bendable, pliable material.

The arms of the device may have an additional ridge of metal along the front of the arms to impart extra strength to the device.

Also, the present application is directed to a method of applying the device in order to lock a hinge so that the door that the hinge is attached to is locked in a closed position. The method is easy to perform, can be performed multiple times on the same device such that the device is portable and may be used and reused in several different locations on several different hinges and hinges located in differing configurations, for example, on a hinge on a door in a corner, on a hinge on a door in a narrow hallway, on a hinge on a cabinet in a small kitchen, on a hinge on a door in a large room. The goal of locking the hinge and the door closed is for the safety of the elderly, children, and others who may be curious or determined to open a door when they should not. For example, a child in a home without the device on the outer door may try to exit the structure late at night or when a caregiver is not watching. This can be very dangerous and could result in injury to the child.

The method may comprise positioning the device over the hinge and adjacent to the door; sliding the device down over the hinge such that the circular inner unit encircles the hinge and the second arm rests on the door; wherein once the device is on the hinge, the door does not open. The method may further comprise removal of the device where the device is slid up off of the hinge so that the circular inner unit no longer encircles the hinge and the device is reusable in the same or different location. The method may further comprise positioning the arms adjacent to the door and the adjacent wall when the device contains a ratchet in the circular inner section. When the device contains a ratchet, the method may further comprise re-setting the device by pressing the release pin to disengage the ratchet system and allow the arms to fold together into a pre-locking position as shown in FIG. 10.

While the present application describes particular embodiments, it is recognized that additional variations of the device may be devised without departing from the inventive concept.

### INDUSTRIAL APPLICABILITY

This device and method may be industrially applied to the development, manufacture, and use of easy to use, portable, reusable, and sturdy safety devices for the elderly, children, and infirm.

What is claimed is:

1. A portable hinge lock device for locking a door having a hinge in the closed position comprising:
(a) a first arm and a second arm, each having a left side, a right side, a length, and a width, the left side of the first arm having a straight vertical shape, and the right side of the second arm having a straight vertical shape, the first arm having its length greater than its height and the second arm having its length greater than its height;
(b) a circular inner unit having a left side and a right side, a front side and a back side, and a hollow inside, the left side of the circular inner unit attached to the right side of the second arm and the right side of the circular inner unit attached to the left side of the first arm, the front side of the circular inner unit rising up from the first arm and second arm and having a circular shape capable of encircling the hinge, and the back side of the circular inner unit having an opening for receiving the hinge in the hollow inside;
wherein the portable hinge lock device fits over the hinge such that the circular inner unit receives the hinge and the first arm and second arm rest on the door or a wall adjacent to the door.

2. The device of claim 1 further comprising a lip on one or more of the arms.

3. The device of claim 1, wherein the device is metal.

4. The device of claim 1, wherein the metal is perforated.

5. The device of claim 1, wherein the second arm has a foldable component.

6. The device of claim 1, wherein the first arm has a foldable component

7. The device of claim 5, wherein the foldable component is vertically disposed on the second arm, and wherein the left side of the second arm can fold up to allow the device to be positioned over the hinge on a door adjacent to a perpendicular wall.

8. The device of claim 6, wherein the foldable component is vertically disposed on the first arm, and wherein the right side of the firs arm can fold up to allow the device to be positioned over the hinge on a door adjacent to a perpendicular wall.

9. The device of claim 1, further comprising two holes in the top of the circular inner unit capable of receiving a pin, wherein insertion of the pin into the two holes securely locks the device on the hinge.

10. The device of claim 1, wherein the first arm and the second arm each have a different length.

11. The device of claim 1, wherein the first arm and the second arm each have an equal length.

12. A portable hinge lock device for locking a door having a hinge in the closed position comprising:
(a) a first arm and a second arm, each having a left side, a right side, a length, and a height, the left side of the first arm having an interlocking edge, and the right side of the second arm having an interlocking edge fitted with the interlocking edge of the left side of the first arm, the first arm having its length greater than its height and the second arm having its length greater than its height;
(b) a circular inner unit formed by the interlocking edges of the left side of the first arm and the right side of the second arm, the circular inner unit having a front side, a back side, a height, and a hollow inside, the front side of the circular inner unit rising up from the first arm and second arm and having a circular shape capable of encircling a semi-circular gear wheel having an inside and an outside, the gear wheel having one or more teeth on the outside, and the back side of the circular inner unit having one or more fingers for engaging the one or more teeth on the gear wheel, and the inside of the gear wheel shaped to receive the hinge; wherein the portable hinge lock device fits over the hinge such that the circular inner unit with gear wheel receives the hinge and the first arm and second arm can be ratcheted into position to rest on the door or a wall adjacent to the door.

13. The device of claim 12, wherein the first arm and the second arm each have an additional support ridge extending from the circular inner unit to the right side of the first arm and from the circular inner unit to the left side of the second arm.

14. The device of claim 12, further comprising a release pin, wherein the release pin disengages the teeth of the gear wheel from the one or more fingers on the back side of the circular inner unit.

15. The device of claim 12, wherein the second arm has a bent shape to accommodate the hinge and door.

16. The device of claim 12, wherein the first arm and second arm have equal lengths.

17. The device of claim 12, wherein the height of the circular inner unit is larger than the right side of the first arm and the left side of the second arm.

18. The device of claim 12, wherein the semi-circular gear wheel is open on the back side of the device and has a size and shape capable of receiving the hinge.

19. A method of using the device of claim 12 comprising:
(a) positioning the device over the hinge and adjacent to the door;
(b) sliding the device over the hinge such that the circular inner unit encircles the hinge and the second arm rests on the door;
wherein once the device is on the hinge, the door does not open.

20. The method of claim 19 further comprising ratcheting the arms down to fit securely adjacent to the door.
